(19) United States
(12) Patent Application Publication
(10) Pub. No.: US 2025/0197633 A1
(43) Pub. Date: Jun. 19, 2025

(54) COMPOSITION, METHOD FOR THE MANUFACTURE THEREOF, AND ARTICLE COMPRISING THE COMPOSITION

(71) Applicant: SHPP GLOBAL TECHNOLOGIES B.V., Bergen op Zoom (NL)

(72) Inventors: Jian Wang, Shanghai (CN); Yun Zheng, Shanghai (CN); Keran Chen, Shanghai (CN)

(21) Appl. No.: 18/849,366

(22) PCT Filed: Mar. 10, 2023
(86) PCT No.: PCT/IB2023/052303

§ 371 Date: Sep. 20, 2024

(30) Foreign Application Priority Data
Mar. 24, 2022 (EP) 22164223.4

(51) Int. Cl. C08L 69/00; C08K 3/32; H01M 50/121

(52) U.S. Cl. CPC C08L 69/00; C08K 3/32; H01M 50/121; C08L 2201/02

(57) ABSTRACT

A composition includes particular amounts of a linear polycarbonate; a branched polycarbonate; and a polycarbonate-siloxane copolymer. Methods of making the composition and articles including the composition are also described.

### CROSS REFERENCE TO RELATED APPLICATION

This application claims priority to and the benefit of European Patent Application No. 22164223.4, filed on Mar. 24, 2022, the contents of which are incorporated by reference herein in their entirety.

### BACKGROUND

This disclosure relates to compositions including a linear polycarbonate, a branched polycarbonate, and a polycarbonate-siloxane, as well as methods for the manufacture thereof, uses, and articles containing the compositions.

Polycarbonate homopolymers and polycarbonate copolymers are useful in a wide variety of applications at least in part because of a good balance of properties, such as moldability, heat resistance and impact properties, among others. Despite extensive research on these materials over the years, there still remains a need in the art for improved polycarbonate compositions that meet increasingly stringent industry standards, particularly with regard to consumer electronics. Achieving a balance of mechanical properties and flame resistance can be challenging, particularly for thin wall applications.

There accordingly remains a need in the art for compositions that can have balanced mechanical properties including low temperature impact strength and flame retardance, particularly at a thickness of less than 1 millimeter.

### SUMMARY

A composition comprises 45 to less than 80 weight percent of a linear polycarbonate; 10 to 30 weight percent of a branched polycarbonate; and greater than 10 to 25 weight percent of a polycarbonate-siloxane copolymer; wherein weight percent of each composition is based on the total weight of the composition; wherein the polycarbonate-siloxane copolymer has a siloxane content of 12 to 60 weight percent based on the total weight of the polycarbonate-siloxane copolymer; and wherein the composition comprises less than 1 weight percent of a flame retardant additive.

A method of making the composition comprises melt-mixing the components of the composition, and, optionally, extruding the composition.

A battery housing comprises the composition.

### DETAILED DESCRIPTION

Provided herein is a composition having a desirable combination of properties, including flame retardance and low temperature impact strength. The present inventors have determined that such properties can be obtained with a composition including particular amounts of a linear polycarbonate, a branched polycarbonate, and a polycarbonate-siloxane copolymer. In an advantageous feature, flame retardant additives can be minimized or excluded from the composition. The compositions described herein can be particularly useful in thin wall applications where good flame retardant properties are required, such as housings for battery modules.

Accordingly, an aspect of the present disclosure is a composition comprising a linear polycarbonate. As used herein, a “linear polycarbonate” refers to a polycarbonate manufactured without the addition of a branching agent. For example, a linear polycarbonate can have less than 0.1 branching units per 100 carbonate units. “Polycarbonate” as used herein means a homopolymer or copolymer having repeating structural carbonate units of the formula (1)

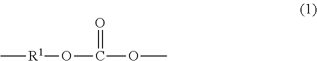

wherein at least 60 percent of the total number of R¹ groups are aromatic, or each R¹ contains at least one C₆₋₃₀ aromatic group. Polycarbonates and their methods of manufacture are known in the art, being described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”), 3,3-bis(4-hydroxyphenyl) phthalimidine, 1,1-bis(4-hydroxy-3-methylphenyl)cyclohexane, or 1,1-bis(4-hydroxyphenyl)-3,3,5-trimethylcyclohexane (isophorone), or a combination thereof can also be used. In an aspect, the linear polycarbonate can be a linear homopolymer derived from BPA; a linear copolymer derived from BPA and another bisphenol or dihydroxy aromatic compound such as resorcinol; or a linear copolymer derived from BPA and optionally another bisphenol or dihydroxyaromatic compound, and further comprising non-carbonate units, for example aromatic ester units such as resorcinol terephthalate or isophthalate, aromatic-aliphatic ester units based on C₆₋₂₀ aliphatic diacids, polysiloxane units such as polydimethylsiloxane units, or a combination thereof.

In an aspect, the linear polycarbonate can be a linear bisphenol A polycarbonate homopolymer comprising repeating structural carbonate units of the formula (2)

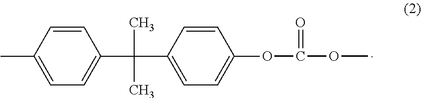

An endcapping agent can be included during polymerization to provide end groups, for example monocyclic phenols such as phenol, p-cyanophenol, and C₁₋₂₂ alkyl-substituted phenols such as p-cumyl-phenol, resorcinol monobenzoate, and p-tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryloyl chloride, and mono-chloroformates such as phenyl chloroformate, alkyl-substituted phenyl chloroformates, p-cumyl phenyl chloroformate, and toluene chloroformate. Phenol and para-cumylphenol are specifically mentioned. Combinations of different endcapping agents can be used.

In an aspect, the linear bisphenol A polycarbonate homopolymer can be optionally endcapped with phenol or para-cumylphenol. The linear bisphenol A polycarbonate can have a weight average molecular weight of 10,000 to 100,000 grams per mole (g/mol), preferably 15,000 to 40,000 g/mol, as measured by gel permeation chromatography (GPC), using a crosslinked styrene-divinylbenzene column and calibrated to bisphenol A polycarbonate standards. GPC samples can be prepared at a concentration of 1 milligram per milliliter (mg/ml) and eluted at a flow rate of 1.5 ml per minute. In an aspect, the linear polycarbonate can comprise a linear bisphenol A polycarbonate homopolymer having a weight average molecular weight of 15,000 to 25,000 grams per mole, preferably 17,000 to 25,000 grams per mole, as determined by GPC. In an aspect, the linear polycarbonate can comprise a linear bisphenol A polycarbonate homopolymer having a weight average molecular weight of 26,000 to 40,000 grams per mole, preferably 27,000 to 35,000 grams per mole, as determined by GPC.

In an aspect, more than one linear polycarbonate can be present. For example, the linear polycarbonate can comprise a first linear bisphenol A polycarbonate homopolymer having a weight average molecular weight of 15,000 to 25,000 g/mol or 17,000 to 23,000 g/mol or 18,000 to 22,000 g/mol, and a second linear bisphenol A polycarbonate homopolymer having a weight average molecular weight of 26,000 to 40,000 g/mol or 26,000 to 35,000 g/mol, each measured by GPC calibrated to bisphenol A polycarbonate standards. The weight ratio of the first bisphenol A polycarbonate homopolymer relative to the second bisphenol A polycarbonate homopolymer can be, for example, 10:1 to 1:10, preferably 5:1 to 1:5, more preferably 3:1 to 1:3 or 2:1 to 1:2.

The linear polycarbonate can be present in the composition in an amount of 45 to less than 80 weight percent, based on the total weight of the composition. Within this range, the linear polycarbonate can be present in an amount of 50 to 80 weight percent, or 50 to 76 weight percent, or 55 to 80 weight percent, or 55 to 76 weight percent, or 55 to 67 weight percent, or 58 to 65 weight percent, or 60 to 70 weight percent, or 60 to 66 weight percent, each based on the total weight of the composition.

In an aspect, when more than one linear polycarbonate is present, the composition can comprise a first linear bisphenol A polycarbonate homopolymer and a second linear bisphenol A polycarbonate homopolymer, each having a molecular weight as described above, and the first linear bisphenol A polycarbonate can be present in an amount of 25 to 75 weight percent, or 25 to 70 weight percent, or 30 to 60 weight percent, or 35 to 55 weight percent, or 40 to 50 weight percent, each based on the total weight of the composition. The second linear bisphenol A polycarbonate can be present in an amount of 5 to 25 weight percent, or 10 to 25 weight percent, or 15 to 25 weight percent, or 10 to 20 weight percent, each based on the total weight of the composition. The total amount of the first and second linear polycarbonate sums to 50 to 80 weight percent, based on the total weight of the composition.

In addition to the linear polycarbonate, the composition comprises a branched polycarbonate. As used herein, “branched polycarbonate” refers to a polycarbonate having statistically more than two end groups. The branched polycarbonate can comprise repeating carbonate units of formula (1) as described above. In an aspect, the branched polycarbonate comprises a branched bisphenol A polycarbonate homopolymer.

Branched polycarbonates can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimelitic anhydride, trisphenol TC (1,3,5-tris(p-hydroxyphenyl)isopropyl)benzene), tris-phenol PA (4(4(1,1-bis(p-hydroxyphenyl)-ethyl) alpha, alpha-dimethyl benzyl)phenol), 4-chloroformylphthalic anhydride, trimesic acid, and benzophenone tetracarboxylic acid.

In an aspect, a particular type of branching agent is used to create branched polycarbonate materials. The branching agent can be added in an amount (relative to the bisphenol monomer) that is sufficient to achieve the desired branching content, that is, more than two end groups. The molecular weight of the polymer can become very high upon addition of the branching agent, and to avoid excess viscosity during polymerization, an increased amount of a chain stopper agent can be used, relative to the amount used when the particular branching agent is not present. The amount of chain stopper used can be, for example, greater than 5 mole percent and less than 20 mole percent compared to the bisphenol monomer (e.g., bisphenol A).

Exemplary branching agents can include aromatic triacyl halides, for example triacyl chlorides of formula (2)

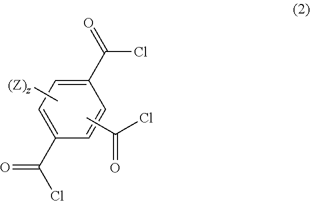

wherein Z is a halogen, C₁₋₃ alkyl, C₁₋₃ alkoxy, C₇₋₁₂ arylalkylene, C₇₋₁₂ alkylarylene, or nitro, and z is 0 to 3; a tri-substituted phenol of formula (3)

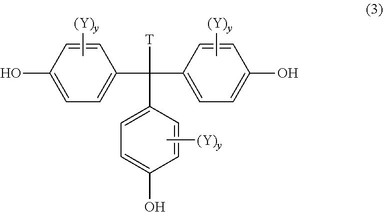

wherein T is a C₁₋₂₀ alkyl, C₁₋₂₀ alkoxy, C₇₋₁₂ arylalkyl, or C₇₋₁₂ alkylaryl, Y is a halogen, C₁₋₃ alkyl, C₁₋₃ alkoxy, C₇₋₁₂ arylalkyl, C₇₋₁₂ alkylaryl, or nitro, s is 0 to 4; or a compound of formula (4) (isatin-bis-phenol)

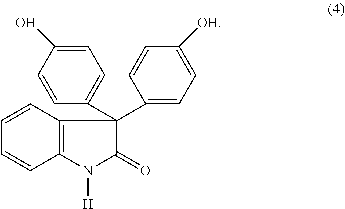 [SMILES: O=C1Nc2ccccc2C1(c1ccc(O)cc1)c1ccc(O)cc1]

Examples of specific branching agents that are particularly effective in the compositions include trimellitic trichloride (TMTC), tris-p-hydroxyphenylethane (THPE), and isatin-bis-phenol.

The amount of the branching agents used in the manufacture of the polymer will depend on a number of considerations, for example the type of R¹ groups, the amount of chain stopper, e.g., cyanophenol, and the desired molecular weight of the polycarbonate. In general, the amount of branching agent can be effective to provide 0.1 to 10 branching units per 100 R¹ units, preferably 0.5 to 8 branching units per 100 R¹ units, and more preferably 0.75 to 5 branching units per 100 R¹ units. For branching agents having formula (2), the branching agent can be present in an amount to provide 0.1 to 10 triester branching units per 100 R¹ units, preferably 0.5 to 8, and more preferably 0.75 to 5 triester branching units per 100 R¹ units. For branching agents having formula (3), the branching agent can be present in an amount effective to provide 0.1 to 10 triphenyl carbonate branching units per 100 R¹ units, preferably 0.5 to 8, and more preferably 2.5 to 3.5 triphenylcarbonate units per 100 R¹ units. In an aspect, a combination of two or more branching agents can be used. Alternatively, the branching agents can be added at a level of 0.05 to 2.0 weight percent.

In an aspect, the branched polycarbonate can comprise repeating carbonate units as described above and greater than or equal to 2 mole percent, or greater than or equal to 3 mole percent, for example 2 to 4 mole percent, based on total moles of polycarbonate, of moieties derived from a branching agent. In an aspect, the branched polycarbonate can further comprise and groups derived from an end-capping agent having a pKa between 8.3 and 11. Exemplary end-capping agents can include, for example, phenol or a phenol containing a substituent of cyano group, aliphatic groups, olefinic groups, aromatic groups, halogens, ester groups, ether groups, or a combination comprising at least one of the foregoing. In a specific aspect, the end-capping agent is phenol, p-t-butylphenol, p-methoxyphenol, p-cyanophenol, p-cumylphenol, or a combination comprising at least one of the foregoing.

The branched polycarbonate can be present in an amount of 10 to 30 weight percent, based on the total weight of the composition. Within this range, the branched polycarbonate can be present in an amount of 12 to 30 weight percent, or 12 to 25 weight percent, or 10 to 25 weight percent, or 18 to 30 weight percent, or 18 to 25 weight percent, or 18 to 23 weight percent, or 19 to 21 weight percent, each based on the total weight of the composition.

In addition to the linear polycarbonate and the branched polycarbonate, the composition further includes a polycarbonate-siloxane copolymer. Polycarbonate-siloxane copolymers are also known as polycarbonate-siloxanes. The polycarbonate-siloxane comprises carbonate repeat units, for example as described above, and siloxane units. The polysiloxane blocks comprise repeating diorganosiloxane units as in formula (5)

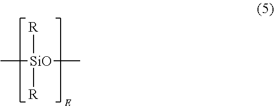

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups can be fully or partially halogenated with fluorine, chlorine, bromine, or iodine, or a combination thereof. In an aspect, where a transparent polycarbonate-siloxane is desired, R is unsubstituted by halogen. Combinations of the foregoing R groups can be used in the same copolymer.

The value of E in formula (5) can vary widely depending on the type and relative amount of each component in the composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it can be desirable to use a relatively larger amount of the polycarbonate-siloxane copolymer. Conversely, where E is of a higher value, e.g., greater than 40, a relatively lower amount of the polycarbonate-siloxane copolymer can be used. A combination of a first and a second (or more) polycarbonate-siloxane copolymers can be used, wherein the average value of E of the first copolymer is less than the average value of E of the second copolymer.

In an aspect, the polysiloxane blocks are of formula (6)

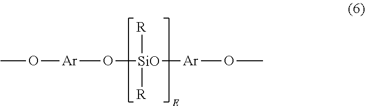

wherein E and R are as defined if formula (5); each R can be the same or different, and is as defined above; and Ar can be the same or different, and is a substituted or unsubstituted C₆₋₃₀ arylene, wherein the bonds are directly connected to an aromatic moiety. Ar groups in formula (6) can be derived from a C₆₋₃₀ dihydroxyarylene compound. Dihydroxyarylene compounds can include 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

In another aspect, polysiloxane blocks are of formula (7)

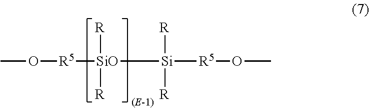

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (8):

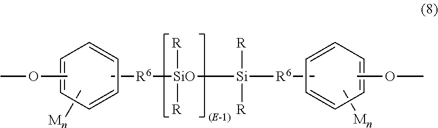

wherein R and E are as defined above. R⁶ in formula (8) is a divalent C₂₋₈ aliphatic group. Each M in formula (8) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

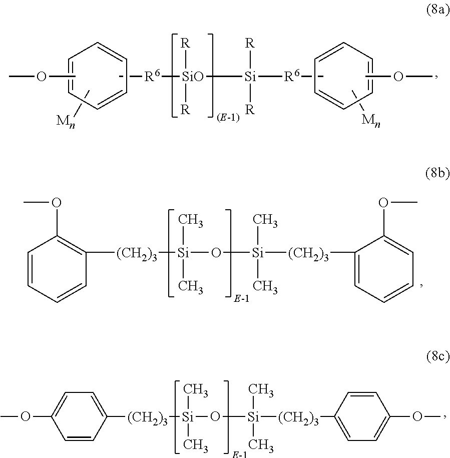

or a combination thereof, wherein E has an average value of 2 to 200, 2 to 125, 5 to 125, 5 to 100, 5 to 50, 20 to 80, or 5 to 20.

Blocks of formula (8) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The polycarbonate-siloxane copolymers can then be manufactured, for example, by the synthetic procedure of European Patent Application Publication No. 0 524 731 A1 of Hoover, page 5, Preparation 2.

Transparent polycarbonate-siloxane copolymers comprise carbonate units (1) derived from bisphenol A, and repeating siloxane units (8a), (8b), (8c), or a combination thereof (preferably of formula 8a), wherein E has an average value of 4 to 50, 4 to 15, preferably 5 to 15, more preferably 6 to 15, and still more preferably 7 to 10. The transparent copolymers can be manufactured using one or both of the tube reactor processes described in U.S. Patent Application No. 2004/0039145A1 or the process described in U.S. Pat. No. 6,723,864 can be used to synthesize the polycarbonate-siloxane copolymers.

The polycarbonate-siloxane copolymers can comprise 40 to 88 weight percent of carbonate units and 12 to 60 weight percent siloxane units. Within this range, the polycarbonate-siloxane copolymer can comprise 70 to 88 weight percent, more preferably 75 to 88 weight percent of carbonate units and 12 to 30 weight percent, more preferably 12 to 25 weight percent siloxane units. In an aspect, the polycarbonate-siloxane copolymer can have a siloxane content of, for example, 12 to 60 weight percent, or 12 to 55 weight percent, or 12 to 50 weight percent, or 15 to 60 weight percent, or 15 to 55 weight percent, 15 to 50 weight percent, or 18 to 60 weight percent, or 18 to 55 weight percent, or 18 to 50 weight percent, based on the total weight of the polycarbonate-siloxane copolymer. For example, the polycarbonate-siloxane copolymer can have a siloxane content of 12 to 30 weight percent, based on the total weight of the polycarbonate-siloxane copolymer. Within this range, the polycarbonate-siloxane copolymer can have a siloxane content of 12 to 25 weight percent, or 15 to 25 weight percent. As used herein, “siloxane content” of a poly(carbonate-siloxane) refers to the content of siloxane units based on the total weight of the polycarbonate-siloxane copolymer.

The polycarbonate-siloxane copolymer can have a weight average molecular weight of 18,000 to 50,000 g/mol, preferably 25,000 to 40,000 g/mol, more preferably 27,000 to 32,000 g/mol as measured by gel permeation chromatography using a crosslinked styrene-divinyl benzene column, at a sample concentration of 1 milligram per milliliter, calibrated with bisphenol A polycarbonate standards.

In an aspect, the composition comprises less than or equal to 5 weight percent or less than or equal to 1 weight percent, or less than or equal to 0.1 weight percent of a polycarbonate-siloxane having a siloxane content of less than or equal to 10 weight percent. Preferably a polycarbonate-siloxane having a siloxane content of less than or equal to 10 weight percent is excluded from the composition.

The polycarbonate-siloxane copolymer can be present in the composition in an amount to provide a total siloxane content of 0.5 to 20 weight percent, or 1 to 10 weight percent, or 1 to 8 weight percent, or 1 to 6 weight percent or 1.5 to 4 weight percent, each based on the total weight of the composition.

The polycarbonate-siloxane copolymer can be present in an amount of greater than 10 to 25 weight percent, based on the total weight of the composition. Within this range, the polycarbonate-siloxane can be present in the composition in amount of 11 to 25 weight percent or 12 to 25 weight percent, or 12 to 20 weight percent, or 15 to 25 weight percent, or 15 to 20 weight percent.

In an aspect, the composition can comprise 50 to 76 weight percent, or 55 to 67 weight percent of the linear polycarbonate; 12 to 25 weight percent, or 18 to 23 weight percent of the branched polycarbonate; and 12 to 25 weight percent, or 15 to 20 weight percent of the polycarbonate-siloxane copolymer.

It will further be understood that the components are present such that the composition totals 100 weight percent.

In an aspect, the composition can comprise 45 to less than 80 weight percent, or 50 to 76 weight percent, or 55 to 67 weight percent of the linear polycarbonate; 10 to 30 weight percent, or 12 to 25 weight percent, or 18 to 23 weight percent of the branched polycarbonate; and greater than 10 to 25 weight percent, or 12 to 25 weight percent, or 15 to 20 weight percent of the polycarbonate-siloxane copolymer, wherein the linear polycarbonate comprises a first linear bisphenol A polycarbonate homopolymer having a weight average molecular weight of 15,000 to 25,000 grams per mole, preferably 17,000 to 25,000 grams per mole, as determined by gel permeation chromatography relative to linear bisphenol A polycarbonate standards, and a second linear bisphenol A polycarbonate homopolymer having a weight average molecular weight of 26,000 to 40,000 grams per mole, preferably 27,000 to 35,000 grams per mole, as determined by gel permeation chromatography relative to linear bisphenol A polycarbonate standards; the branched polycarbonate comprises a branched bisphenol A polycarbonate homopolymer comprising 2 to 4 mol % of a branching agent; the polycarbonate-siloxane copolymer comprises bisphenol A carbonate repeating units and poly(dimethyl siloxane) repeating units; and the polycarbonate-siloxane copolymer has a siloxane content of 15 to 25 weight percent based on the total weight of the polycarbonate-siloxane copolymer.

The composition can optionally further comprise an additive composition comprising one or more additives ordinarily incorporated into polymer compositions of this type, provided that the one or more additives are selected so as not to significantly adversely affect the desired properties of the composition, in particular impact strength, and flame retardance. Additives can include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a stabilizer, a colorant, and a mold release agent. The additives are used in the amounts generally known to be effective. For example, the total amount of the additives (other than any impact modifier, filler, or reinforcing agents) can be 0.01 to 5 weight percent, based on the total weight of the composition. In an aspect, the composition comprises no more than 5 weight percent based on the weight of the composition of a stabilizer, a colorant, and a mold release agent, or a combination thereof.

The composition can optionally exclude other components not specifically described herein. For example, the composition can exclude thermoplastic polymers other than the linear polycarbonate, the branched polycarbonate, and the polycarbonate-siloxane copolymer. For example, the composition can minimize or exclude polyesters (e.g., a polyester can be present in an amount of 1 weight percent or less, preferably wherein a polyester is excluded from the composition). The composition can optionally exclude a polycarbonate other than the linear bisphenol A homopolycarbonate, the branched bisphenol homopolycarbonate, and the polycarbonate-siloxane copolymer (e.g., a polycarbonate comprising repeating units derived from bisphenol A and poly(dimethylsiloxane), for example a polyester-carbonate or a bisphenol A copolycarbonate different from the polycarbonate-siloxane copolymer). The composition can optionally exclude impact modifiers, for example silicone-based impact modifiers different from the polycarbonate-siloxane copolymer, methyl methacrylate-butadiene-styrene copolymers, acrylonitrile-butadiene, styrene copolymers, and the like, or a combination thereof. The composition can exclude flame retardants, for example halogenated flame retardants such as brominated flame retardants, including brominated polycarbonate (e.g., a polycarbonate containing brominated carbonate includes units derived from 2,2′,6,6′-tetrabromo-4,4′-isopropylidenediphenol (TBBPA) and carbonate units derived from at least one dihydroxy aromatic compound that is not TBBPA), brominated epoxies, and the like or combinations thereof. The composition can optionally minimize or exclude phosphorus-containing flame retardants, for example phosphazene flame retardants. For example, the composition can comprise less than 1 weight percent, or less than 0.5 weight percent, or less than 0.1 weight percent of a flame retardant additive, for example less than 1 weight percent, or less than 0.5 weight percent, or less than 0.1 weight percent of a phosphorus-containing flame retardant additive, for example less than 1 weight percent, or less than 0.5 weight percent, or less than 0.1 weight percent of a phosphazene flame retardant. In an aspect, the composition can exclude impact modifiers. In an aspect, the composition can comprise less than 1 weight percent, or less than 0.1 weight percent any polymer other than the linear polycarbonate, the branched polycarbonate, and the polycarbonate-siloxane copolymer. In an aspect, the composition can exclude any polymer other than the linear polycarbonate, the branched polycarbonate, and the polycarbonate-siloxane copolymer. In an aspect the composition can minimize or exclude reinforcing fillers, including, but not limited to, glass fiber, carbon fiber, metal fiber, whiskers, glass flake, mineral filler, or a combination thereof. For example, the composition can comprise less than 5 weight percent, or less than 1 weight percent, or less than 0.1 weight percent of a reinforcing filler. In an aspect, the composition can exclude a reinforcing filler.

The composition can advantageously exhibit one or more desirable properties. For example, it was found that improved impact strength was obtained by combining particular amounts of the linear polycarbonate, the branched polycarbonate, and the polycarbonate-siloxane copolymer. For example, a molded sample of the composition exhibits: a notched Izod impact strength of greater than 800 J/m, as measured in accordance with ASTM D256 at 23° C. under a 22.24 N (5 lbf) load; and a notched Izod impact strength of greater than 600 J/m, as measured in accordance with ASTM D256 at −30° C. under a 22.24 N (5 lbf) load.

In a particularly advantageous feature, the compositions can provide improved flame retardance, particularly for thin wall parts, as determined by the needle flame test in accordance with IEC60695-11-5:2016. For example, a molded article having a total thickness of less than 800 micrometers comprising the composition does not burn through after at least 80 seconds in the needle flame test according to IEC60695-11-5:2016, wherein the molded article comprises the composition having a thickness of 585 to 645 micrometers overmolded onto a polycarbonate film having a thickness of 100 to 150 micrometers and a polyurethane-acrylate hardcoating having a thickness of 5 to 15 micrometers disposed on the composition on a side opposite the polycarbonate film.

The composition can be manufactured by various methods known in the art. For example, powdered linear polycarbonate, branched polycarbonate, poly(carbonate-siloxane) and other optional components are first blended, optionally with any fillers, in a high-speed mixer or by hand mixing. The blend is then fed into the throat of a twin-screw extruder via a hopper. Alternatively, at least one of the components can be incorporated into the composition by feeding it directly into the extruder at the throat and/or downstream through a side stuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Shaped, formed, casted, or molded articles comprising the composition are also provided. The composition can be molded into useful shaped articles by a variety of methods, such as injection molding, extrusion, rotational molding, blow molding, and thermoforming. The article can be a molded article, a thermoformed article, an extruded film, an extruded sheet, a honeycomb structure, one or more layers of a multi-layer article, a substrate for a coated article, and a substrate for a metallized article. Exemplary articles can include medical housings, automotive components, and consumer electronics. In an aspect, a molded article comprising the composition can have a thickness of less than 1 mm, or less than 0.8 mm.

In an aspect an article can be a battery housing. The battery housing can be a component of a battery module. The battery housing can enclose a battery module interior which can accommodate a given number of battery cells. A preselected number of battery cells can be combined to form a battery module, which is surround by a battery module housing (also referred to herein as a “battery housing”). A plurality of the battery modules can also be combined to form a battery pack, which in turn can be installed in a consumer electronic device. The battery housing can generally be suited for a battery of any shape, for example flat battery cells, or cylindrical battery cells.

Previous battery cells can pose a significant threat in the event of damage to or short circuiting of the battery cell. In order to reduce the potential danger of these battery modules, it can be desirable to provide a battery housing around the battery cells which can improve the safety of the battery cells. The composition of the present disclosure, having improved impact and flame retardant properties, can therefore be particularly useful as a battery housing. Advantageously, a wall of the battery housing comprising the composition of the present disclosure, in a flame needle test according to IEC60695-11-5:2016, burns through after more than 80 seconds.

In an aspect, a wall of the battery housing comprising the composition can have a thickness of less than 1 mm, or less than 0.8 mm.

This disclosure is further illustrated by the following examples, which are non-limiting.

### Examples

Materials used in the following examples are described in Table 1.

TABLE 1

| Component | Description | Supplier |
|---|---|---|
| PC-Si | Bisphenol A polycarbonate- | SABIC |
| | polydimethylsiloxane copolymer including | |
| | 20 wt % siloxane, having an average siloxane | |
| | block length of 45 units, and having a Mw | |
| | 29,000-31,000 g/mol as determined by GPC | |
| | using polycarbonate standards, eugenol end- | |
| | capped | |
| PC-1 | Linear bisphenol A polycarbonate, CAS Reg. | SABIC |
| | No, 25971-63-5, having a molecular weight | |
| | (Mw) of 30,000-31,000 grams per mole, as | |
| | determined by gel permeation chromatography | |
| | relative to linear bisphenol A polycarbonate | |
| | standards, produced by interfacial | |
| | polymerization and endcapped with | |
| | p-cumylphenol | |
| PC-2 | Linear bisphenol A polycarbonate having a | SABIC |
| | Mw of 20,000-22,000 grams per mole, as | |
| | determined by gel permeation chromatography | |
| | relative to linear bisphenol A polycarbonate | |
| | standards, produced by interfacial | |
| | polymerization and endcapped with | |
| | p-cumylphenol | |
| PC-3 | Branched, cyanophenol end-capped bisphenol | SABIC |
| | A homopolycarbonate containing 3 mol % | |
| | 1,1,1-tris(4-hydroxyphenyl)ethane (THPE) | |
| | branching agent | |
| TBPP | Tris(2,4-di-tert-butylphenyl) phosphite, CAS | BASF |
| | Reg. No. 31570-04-4; available as IRGAFOS | Corp. |
| | 168 | |
| PETS | Pentaerythritol tetrastearate | FACI |
| CB | Carbon black, CAS No. 1333-86-4 | Cabot |

The compositions of the following examples were prepared by blending the components together and extruding on a 37 mm twin-screw extruder. The compositions were subsequently injection molded at a temperature of 270 to 320° C., though it will be recognized by one skilled in the art that the method is not limited to these temperatures. Extrusion and molding conditions are shown in Tables 2 and 3, respectively.

TABLE 2

| Parameters | Unit | Condition |
|---|---|---|
| Compounder Type | | TEM-37BS |
| Barrel Size | mm | 1500 |
| Die | mm | 4 |
| Zone 1 Temp | ° C. | 50 |
| Zone 2 Temp | ° C. | 100 |
| Zone 3 Temp | ° C. | 200 |
| Zone 4 Temp | ° C. | 260 |
| Zone 5 Temp | ° C. | 260 |
| Zone 6 Temp | ° C. | 260 |
| Zone 7 Temp | ° C. | 260 |
| Zone 8 Temp | ° C. | 260 |
| Zone 9 Temp | ° C. | 260 |
| Zone 10 Temp | ° C. | 265 |
| Zone 11 Temp | ° C. | 265 |
| Die Temp | ° C. | 265 |
| Screw speed | rpm | 300 |
| Throughput | kg/hr | 40 |
| Torque | % | 70-80 |
| Vacuum 1 | bar | −0.08 |

TABLE 3

| Parameters | Unit | Condition |
|---|---|---|
| Cnd: Pre-drying time | Hour | 4 |
| Cnd: Pre-drying temp | ° C. | 120 |
| Molding Machine | | FANUC |
| Mold Type (insert) | | ASTM Tensile, |
| | | Flexural, & |
| | | IZOD bars; |
| | | part having a total |
| | | thickness <0.8 m, |
| | | over molded onto |
| | | a PC film with |
| | | PUA hard coating |
| Hopper temp | ° C. | 50 |
| Zone 1 temp | ° C. | 270-290 |
| Zone 2 temp | ° C. | 280-300 |
| Zone 3 temp | ° C. | 290-320 |
| Nozzle temp | ° C. | 290-310 |
| Mold temp | ° C. | 90 |
| Screw speed | rpm | 100 |
| Back pressure | kgf/cm² | 50 |
| Cooling time | S | 20-30 |
| Injection speed | mm/s | 50-100 |
| Holding pressure | kgf/cm² | 600-1500 |
| Max. Injection pressure | kgf/cm² | 1000-2000 |

Physical measurements were made using the following test methods.

Melt volume rate (MVR) was determined in accordance with ISO 1133 under a load of 1.2 kg at 300° C.

Notched Izod impact Strength (NII) was determined in accordance with ASTM D256 under a load of 22.24 N (5 lbf) at a temperature of 23° C. or −30° C. on 63.5×12.7×3.2 mm bars.

Heat deflection temperature (HDT) was determined in accordance with ASTM D648 on 127×12.7×3.2 mm bars at 0.45 MPa and 1.82 MPa.

Flexural properties were measured in accordance with ASTM D790 at 1.27 mm/min at a temperature of 23° C. on 127×12.7×3.2 mm bars.

Tensile properties were measured in accordance with ASTM D638 at 50 mm/min at a temperature of 23° C. on standard tensile bars.

Flammability was assessed using a needle flame test according to IEC60695-11-5:2016. Compositions were overmolded onto a polycarbonate film having a thickness of 100-150 micrometers with a polyurethane-acrylate (PUA) hard coating having a thickness of 5-15 micrometers. The total thickness of the sample was approximately 750 micrometers. Results are reported in terms of total number of samples tested versus the number of samples which burned through after exposure to a flame for 80 seconds.

Compositions and properties are shown in Table 5. The amount of each component is provided in weight percent (wt %), based on the total weight of the composition.

TABLE 5

| Components | Units | CE1 | E1 |
|---|---|---|---|
| PC-Si | wt % | 17.5 | 17.5 |
| PC-1 | wt % | 37.5 | 15 |
| PC-2 | wt % | 44.37 | 46.87 |
| PC-3 | wt % | | 20 |
| TBPP | wt % | 0.03 | 0.03 |
| PETS | wt % | 0.3 | 0.3 |
| CB | wt % | 0.3 | 0.3 |
| Total | wt % | 100 | 100 |
| Flammability | | 13/1 | 120/0 |
| MVR | cm³/10 min | 9 | 10 |
| NII, 23° C. | J/m | 865 | 833 |
| NII, −30° C. | J/m | 774 | 675 |
| HDT, 1.82 MPa | MPa | 124 | 121 |
| HDT, 0.45 MPA | MPa | 139 | 135 |
| Flexural Modulus | MPa | 2230 | 2220 |
| Flexural Strength @ yield | MPa | 92 | 92 |
| Tensile Modulus | MPa | 2020 | 1950 |
| Tensile Strength @ yield | MPa | 55 | 57 |
| Tensile Elongation @ yield | % | 6.0 | 5.8 |
| Tensile Strength @ break | MPa | 50 | 58 |
| Tensile Elongation @ break | % | 98 | 89 |

As shown in Table 5, when the branched polycarbonate component (PC-3) was omitted as in Comparative Example 1, the composition could not pass the flammability testing, with one out of thirteen samples tested burning through. In contrast, the composition according to Example 1 exhibited robust anti-flammability, with none of the 120 samples tested failing (i.e., no burning through was observed). Further, the composition according to Example 1 also exhibited good mechanical performance, especially with regard to low temperature ductility. Accordingly, the composition of Example 1 exhibited a desirable combination of properties.

This disclosure further encompasses the following aspects.

Aspect 1: A composition comprising: 45 to less than 80 weight percent of a linear polycarbonate; 10 to 30 weight percent of a branched polycarbonate; and greater than 10 to 25 weight percent of a polycarbonate-siloxane copolymer; wherein weight percent of each composition is based on the total weight of the composition; wherein the polycarbonate-siloxane copolymer has a siloxane content of 12 to 60 weight percent based on the total weight of the polycarbonate-siloxane copolymer; and wherein the composition comprises less than 1 weight percent of a flame retardant additive.

Aspect 2: The composition of aspect 1, wherein the composition comprises less than 0.5 weight percent of a flame retardant additive, preferably wherein the flame retardant additive is a phosphazene compound.

Aspect 3: The composition of aspect 1 or 2, wherein a molded sample of the composition exhibits: a notched Izod impact strength of greater than 800 J/m, as measured in accordance with ASTM D256 at 23° C. under a 22.24 N (5 lbf) load; and a notched Izod impact strength of greater than 600 J/m, as measured in accordance with ASTM D256 at −30° C. under a 22.24 N (5 lbf) load.

Aspect 4: The composition of any of aspects 1 to 3, wherein a molded article having a total thickness of less than 800 micrometers comprising the composition does not burn through after at least 80 seconds in the needle flame test according to IEC60695-11-5:2016; wherein the molded article comprises the composition having a thickness of 585 to 645 micrometers overmolded onto a polycarbonate film having a thickness of 100 to 150 micrometers and a polyurethane-acrylate hardcoating having a thickness of 5 to 15 micrometers disposed on the composition on a side opposite the polycarbonate film.

Aspect 5: The composition of any of aspects 1 to 4, wherein the linear polycarbonate comprises a linear bisphenol A polycarbonate homopolymer having a weight average molecular weight of 15,000 to 40,000 grams per mole, as determined by gel permeation chromatography relative to linear bisphenol A polycarbonate standards, preferably wherein the linear bisphenol A polycarbonate homopolymer has a weight average molecular weight of 15,000 to 40,000 grams per mole, as determined by gel permeation chromatography relative to linear bisphenol A polycarbonate standards.

Aspect 6: The composition of any of aspects 1 to 5, wherein the linear polycarbonate comprises a linear bisphenol A polycarbonate homopolymer having a weight average molecular weight of 15,000 to 25,000 grams per mole, preferably 17,000 to 25,000 grams per mole, as determined by gel permeation chromatography relative to linear bisphenol A polycarbonate standards; or a linear bisphenol A polycarbonate homopolymer having a weight average molecular weight of 26,000 to 40,000 grams per mole, preferably 27,000 to 35,000 grams per mole, as determined by gel permeation chromatography relative to linear bisphenol A polycarbonate standards; or a combination thereof.

Aspect 7: The composition of any of aspects 1 to 6, wherein the branched polycarbonate comprises a branched bisphenol A polycarbonate homopolymer comprising 2 to 4 mol % of a branching agent.

Aspect 8: The composition of any of aspects 1 to 7, wherein the polycarbonate-siloxane copolymer comprises bisphenol A carbonate repeating units and poly(dimethyl siloxane) repeating units.

Aspect 9: The composition of any of aspects 1 to 8, wherein the polycarbonate-siloxane copolymer has a siloxane content of 15 to 25 weight percent based on the total weight of the polycarbonate-siloxane copolymer.

Aspect 10: The composition of any of aspects 1 to 9, further comprising an additive, preferably wherein the additive comprises a stabilizer, a colorant, a mold release agent, or a combination thereof.

Aspect 11: The composition of any of aspects 1 to 10, comprising 50 to 76 weight percent, or 55 to 67 weight percent of the linear polycarbonate; 12 to 25 weight percent, or 18 to 23 weight percent of the branched polycarbonate; and 12 to 25 weight percent, or 15 to 20 weight percent of the polycarbonate-siloxane copolymer.

Aspect 12: The composition of aspect 11, wherein the linear polycarbonate comprises a first linear bisphenol A polycarbonate homopolymer having a weight average molecular weight of 15,000 to 25,000 grams per mole, preferably 17,000 to 25,000 grams per mole, as determined by gel permeation chromatography relative to linear bisphenol A polycarbonate standards, and a second linear bisphenol A polycarbonate homopolymer having a weight average molecular weight of 26,000 to 40,000 grams per mole, preferably 27,000 to 35,000 grams per mole, as determined by gel permeation chromatography relative to linear bisphenol A polycarbonate standards; the branched polycarbonate comprises a branched bisphenol A polycarbonate homopolymer comprising 2 to 4 mol % of a branching agent; the polycarbonate-siloxane copolymer comprises bisphenol A carbonate repeating units and poly(dimethyl siloxane) repeating units; and the polycarbonate-siloxane copolymer has a siloxane content of 15 to 25 weight percent based on the total weight of the polycarbonate-siloxane copolymer.

Aspect 13: A method of making the composition of any of aspects 1 to 12, the method comprising melt-mixing the components of the composition, and, optionally, extruding the composition.

Aspect 14: A battery housing comprising the composition of any of aspects 1 to 12.

Aspect 15: The battery housing of aspect 14, wherein the battery housing has a thickness of less than 1 mm, or less than 0.8 mm.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising:
45 to less than 80 weight percent of a linear polycarbonate;
10 to 30 weight percent of a branched polycarbonate; and
greater than 10 to 25 weight percent of a polycarbonate-siloxane copolymer having cyanophenol endcaps;
wherein weight percent of each composition is based on the total weight of the composition;
wherein the polycarbonate-siloxane copolymer has a siloxane content of 12 to 60 weight percent based on the total weight of the polycarbonate-siloxane copolymer; and
wherein the composition comprises less than 1 weight percent of a flame retardant additive.

2. The composition of claim 1, wherein the composition comprises less than 0.5 weight percent of a flame retardant additive, preferably wherein the flame retardant additive is a phosphorus-containing flame retardant, more preferably wherein the flame retardant additive is a phosphazene compound.

3. The composition of claim 1, wherein a molded sample of the composition exhibits:
a notched Izod impact strength of greater than 800 J/m, as measured in accordance with ASTM D256 at 23° C. under a 22.24 N (5 lbf) load; and
a notched Izod impact strength of greater than 600 J/m, as measured in accordance with ASTM D256 at −30° C. under a 22.24 N (5 lbf) load.

4. The composition of claim 1, wherein a molded article having a total thickness of less than 800 micrometers comprising the composition does not burn through after at least 80 seconds in the needle flame test according to IEC60695-11-5:2016;
wherein the molded article comprises the composition having a thickness of 585 to 645 micrometers overmolded onto a polycarbonate film having a thickness of 100 to 150 micrometers and a polyurethane-acrylate hardcoating having a thickness of 5 to 15 micrometers disposed on the composition on a side opposite the polycarbonate film.

5. The composition of claim 1, wherein the linear polycarbonate comprises a linear bisphenol A polycarbonate homopolymer having a weight average molecular weight of 15,000 to 40,000 grams per mole, as determined by gel permeation chromatography relative to linear bisphenol A polycarbonate standards,
preferably wherein the linear bisphenol A polycarbonate homopolymer has a weight average molecular weight of 15,000 to 40,000 grams per mole, as determined by gel permeation chromatography relative to linear bisphenol A polycarbonate standards.

6. The composition of claim 1, wherein the linear polycarbonate comprises
a linear bisphenol A polycarbonate homopolymer having a weight average molecular weight of 15,000 to 25,000 grams per mole, preferably 17,000 to 25,000 grams per mole, as determined by gel permeation chromatography relative to linear bisphenol A polycarbonate standards; or
a linear bisphenol A polycarbonate homopolymer having a weight average molecular weight of 26,000 to 40,000 grams per mole, preferably 27,000 to 35,000 grams per mole, as determined by gel permeation chromatography relative to linear bisphenol A polycarbonate standards; or
a combination thereof.

7. The composition of claim 1, wherein the branched polycarbonate comprises a branched bisphenol A polycarbonate homopolymer comprising 2 to 4 mol % of a branching agent.

8. The composition of claim 1, wherein the polycarbonate-siloxane copolymer comprises bisphenol A carbonate repeating units and poly(dimethyl siloxane) repeating units.

9. The composition of claim 1, wherein the polycarbonate-siloxane copolymer has a siloxane content of 15 to 25 weight percent based on the total weight of the polycarbonate-siloxane copolymer.

10. The composition of claim 1, further comprising an additive, preferably wherein the additive comprises a stabilizer, a colorant, a mold release agent, or a combination thereof.

11. The composition of claim 1, comprising
50 to 76 weight percent, or 55 to 67 weight percent of the linear polycarbonate;
12 to 25 weight percent, or 18 to 23 weight percent of the branched polycarbonate; and
12 to 25 weight percent, or 15 to 20 weight percent of the polycarbonate-siloxane copolymer.

12. The composition of claim 11, wherein
the linear polycarbonate comprises
a first linear bisphenol A polycarbonate homopolymer having a weight average molecular weight of 15,000 to 25,000 grams per mole, preferably 17,000 to 25,000 grams per mole, as determined by gel permeation chromatography relative to linear bisphenol A polycarbonate standards, and
a second linear bisphenol A polycarbonate homopolymer having a weight average molecular weight of 26,000 to 40,000 grams per mole, preferably 27,000 to 35,000 grams per mole, as determined by gel permeation chromatography relative to linear bisphenol A polycarbonate standards;
the branched polycarbonate comprises a branched bisphenol A polycarbonate homopolymer comprising 2 to 4 mol % of a branching agent;
the polycarbonate-siloxane copolymer comprises bisphenol A carbonate repeating units and poly(dimethyl siloxane) repeating units; and
the polycarbonate-siloxane copolymer has a siloxane content of 15 to 25 weight percent based on the total weight of the polycarbonate-siloxane copolymer.

13. A method of making the composition of claim 1, the method comprising melt-mixing the components of the composition, and, optionally, extruding the composition.

14. A battery housing comprising the composition of claim 1.

15. The battery housing of claim 14, wherein the battery housing has a thickness of less than 1 mm, or less than 0.8 mm.
